(19) United States
(12) Patent Application Publication
(10) Pub. No.: US 2026/0031020 A1
(43) Pub. Date: Jan. 29, 2026

(54) DISPLAY DEVICE

(71) Applicant: Samsung Display Co., Ltd., Yongin-si (KR)

(72) Inventors: YOUNGWAN SEO, Yongin-si (KR); JUNKI JEONG, Yongin-si (KR); Jongyeop An, Yongin-si (KR)

(21) Appl. No.: 19/185,075

(22) Filed: Apr. 21, 2025

(30) Foreign Application Priority Data
Jul. 29, 2024 (KR) 10-2024-0100085

(51) Int. Cl. G09G 3/32; G09G 3/3233

(52) U.S. Cl. CPC G09G 3/32; G09G 3/3233; G09G 2300/0819; G09G 2300/0842; G09G 2310/08; G09G 2320/0285; G09G 2330/021; G09G 2360/16

(57) ABSTRACT

A display device includes: a display panel including a plurality of pixels, the display panel being divided into a plurality of panel regions; and a panel driver configured to drive the display panel based on input image data, and to provide a plurality of power supply voltages to the plurality of panel regions, respectively, wherein the panel driver is further configured to: divide the input image data for the display panel into a plurality of region image data for the plurality of panel regions; determine a target voltage level of each of the plurality of power supply voltages by analyzing a corresponding one of plurality of region image data; and change each of the plurality of power supply voltages to the target voltage level in an end portion of an emission period for a corresponding one of the plurality of panel regions.

### CROSS-REFERENCE TO RELATED APPLICATION

The present application claims priority to and the benefit of Korean Patent Application No. 10-2024-0100085, filed on Jul. 29, 2024, in the Korean Intellectual Property Office, the entire disclosure of which is incorporated herein by reference.

### BACKGROUND

### 1. Field

Aspects of some embodiments of the present disclosure relate to a display device.

### 2. Description of the Related Art

In a display device, such as an organic light emitting diode (“OLED”) display device, a power supply voltage (e.g., a high power supply voltage) provided to a display panel may be determined or set to be sufficiently high in consideration of a drain-source voltage of a driving transistor of each pixel, a voltage applied to an OLED and a voltage drop (e.g., an IR drop) margin of the power supply voltage. Further, when the display panel displays a low luminance image (or a low gray image), the power supply voltage may be set lower than the power supply voltage when the display panel displays a high luminance image (or a high gray image). Thus, the power consumption of the display device may be reduced when the display panel displays the low luminance image (or the low gray image).

However, in some display devices, the same power supply voltage may be applied to all pixels of the display panel. Accordingly, even if a low luminance image is displayed only in a portion of the display panel, the power supply voltage cannot be decreased, and thus the power consumption of the display device cannot be reduced.

The above information disclosed in this Background section is only for enhancement of understanding of the background and therefore the information discussed in this Background section does not necessarily constitute prior art.

### SUMMARY

Aspects of some embodiments of the present disclosure relate to a display device, and for example, to a display device capable of relatively reducing power consumption.

Some embodiments provide a display device capable of relatively reducing power consumption while relatively reducing or minimizing a luminance change.

Some embodiments provide a method of operating a display device capable of relatively reducing power consumption while relatively reducing or minimizing a luminance change.

According to some embodiments of the present disclosure, there is provided a display device including a display panel including a plurality of pixels, the display panel being divided into a plurality of panel regions, and a panel driver configured to drive the display panel based on input image data, and to provide a plurality of power supply voltages to the plurality of panel regions, respectively. According to some embodiments, the panel driver divides the input image data for the display panel into a plurality of region image data for the plurality of panel regions, determines a target voltage level of each of the plurality of power supply voltages by analyzing a corresponding one of plurality of region image data, and changes each of the plurality of power supply voltages to the target voltage level in an end portion of an emission period for a corresponding one of the plurality of panel regions.

According to some embodiments, the plurality of panel regions may respectively include a plurality of mesh lines that are electrically disconnected from each other, and the panel driver may provide the plurality of power supply voltages to the plurality of mesh lines of the plurality of panel regions, respectively.

According to some embodiments, the panel driver may calculate an average gray level of a plurality of gray levels represented by a plurality of pixel data included in the corresponding one of plurality of region image data, and may determine the target voltage level of a corresponding one of the plurality of power supply voltages based on the average gray level.

According to some embodiments, the panel driver may include a gray-voltage lookup table configured to store a plurality of voltage levels corresponding to a plurality of gray ranges. According to some embodiments, the panel driver may receive a voltage level corresponding to a gray range to which the average gray level belongs among the plurality of gray ranges from the gray-voltage lookup table, and may determine the target voltage level of the corresponding one of the plurality of power supply voltages as the voltage level received from the gray-voltage lookup table.

According to some embodiments, each of the plurality of panel regions may include the plurality of pixels arranged in first through N-th pixel rows, where N is an integer greater than 1. According to some embodiments, emission periods for the first through N-th pixel rows may be shifted by one horizontal time per each pixel row. According to some embodiments, the panel driver may change a corresponding one of the plurality of power supply voltages to the target voltage level within a period in which the emission periods overlap each other.

According to some embodiments, each of the plurality of panel regions may include the plurality of pixels arranged in first through N-th pixel rows, where N is an integer greater than 1. According to some embodiments, the panel driver may change a corresponding one of the plurality of power supply voltages to the target voltage level one horizontal time before an end time point of an emission period for the first pixel row that is an uppermost pixel row among the first through N-th pixel rows.

According to some embodiments, each of the plurality of pixels may include a first transistor including a gate connected to a gate node, a drain, and a source connected to a source node, a second transistor configured to transfer a data voltage to the gate node in response to a write signal, a third transistor configured to transfer a reference voltage to the gate node in response to a reference signal, a fourth transistor configured to transfer an initialization voltage to an anode of a light emitting element in response to an initialization signal, a fifth transistor configured to transfer a corresponding one of the plurality of power supply voltages to the drain of the driving transistor in response to a first emission signal, a sixth transistor configured to connect the source node to the anode of the light emitting element in response to a second emission signal, a storage capacitor including a first electrode connected to the gate node, and a second electrode connected to the source node, a hold capacitor including a first electrode which receives the reference voltage, and a second electrode connected to the source node, and the light emitting element including the anode connected to the fourth and sixth transistors, and a cathode which receives a low power supply voltage.

According to some embodiments, the first transistor may further include a bottom gate connected to the source node.

According to some embodiments, the second transistor may include a gate which receives the write signal, a first terminal connected to a data line, and a second terminal connected to the gate node, the third transistor may include a gate which receives the reference signal, a first terminal which receives the reference voltage, and a second terminal connected to the gate node, the fourth transistor may include a gate which receives the initialization signal, a first terminal connected to the anode of the light emitting element, and a second terminal which receives the initialization voltage, the fifth transistor may include a gate which receives the first emission signal, a first terminal which receives the corresponding one of the plurality of power supply voltages, and a second terminal connected to the drain of the driving transistor, and the sixth transistor may include a gate which receives the second emission signal, a first terminal connected to the source node, and a second terminal connected to the anode of the light emitting element.

According to some embodiments, the panel driver may include a data driver configured to provide data voltages to the plurality of pixels, a scan driver configured to provide scan signals to the plurality of pixels, an emission driver configured to provide emission signals to the plurality of pixels, a power management circuit configured to provide the plurality of power supply voltages to the plurality of panel regions, respectively, and a controller configured to control the data driver, the scan driver, the emission driver and the power management circuit.

According to some embodiments of the present disclosure, a display device includes a display panel including a plurality of pixels, the display panel being divided into a plurality of panel regions, and a panel driver configured to drive the display panel based on input image data, and to provide a plurality of power supply voltages to the plurality of panel regions, respectively. According to some embodiments, the panel driver divides the input image data for the display panel into a plurality of region image data for the plurality of panel regions, determines a target voltage level of each of the plurality of power supply voltages by analyzing a corresponding one of plurality of region image data, and gradually changes each of the plurality of power supply voltages to the target voltage level over a plurality of frame periods.

According to some embodiments, the plurality of panel regions may respectively include a plurality of mesh lines that are electrically disconnected from each other, and the panel driver may provide the plurality of power supply voltages to the plurality of mesh lines of the plurality of panel regions, respectively.

According to some embodiments, the panel driver may calculate an average gray level of a plurality of gray levels represented by a plurality of pixel data included in the corresponding one of plurality of region image data, and may determine the target voltage level of a corresponding one of the plurality of power supply voltages based on the average gray level.

According to some embodiments, the panel driver may include a gray-voltage lookup table configured to store a plurality of voltage levels corresponding to a plurality of gray ranges. According to some embodiments, the panel driver may receive a voltage level corresponding to a gray range to which the average gray level belongs among the plurality of gray ranges from the gray-voltage lookup table, and may determine the target voltage level of the corresponding one of the plurality of power supply voltages as the voltage level received from the gray-voltage lookup table.

According to some embodiments, the panel driver may change a corresponding one of the plurality of power supply voltages by a predetermined delta voltage in each of the plurality of frame periods until a voltage level of the corresponding one of the plurality of power supply voltages becomes the target voltage level.

According to some embodiments, each of the plurality of panel regions may include the plurality of pixels arranged in first through N-th pixel rows, where N is an integer greater than 1. According to some embodiments, non-emission periods for the first through N-th pixel rows may be shifted by one horizontal time per each pixel row. According to some embodiments, the panel driver may change a corresponding one of the plurality of power supply voltages by a predetermined delta voltage in a period in which the non-emission periods overlap within each of the plurality of frame periods.

According to some embodiments, each of the plurality of panel regions may include the plurality of pixels arranged in first through N-th pixel rows, where N is an integer greater than 1. According to some embodiments, the panel driver may change a corresponding one of the plurality of power supply voltages by a predetermined delta voltage one horizontal time before an end time point of an emission period for the first pixel row that is an uppermost pixel row among the first through N-th pixel rows in each of the plurality of frame periods.

According to some embodiments, each of the plurality of pixels may include a first transistor including a gate connected to a gate node, a drain, and a source connected to a source node, a second transistor configured to transfer a data voltage to the gate node in response to a write signal, a third transistor configured to transfer a reference voltage to the gate node in response to a reference signal, a fourth transistor configured to transfer an initialization voltage to an anode of a light emitting element in response to an initialization signal, a fifth transistor configured to transfer a corresponding one of the plurality of power supply voltages to the drain of the driving transistor in response to a first emission signal, a sixth transistor configured to connect the source node to the anode of the light emitting element in response to a second emission signal, a storage capacitor including a first electrode connected to the gate node, and a second electrode connected to the source node, a hold capacitor including a first electrode which receives the reference voltage, and a second electrode connected to the source node, and the light emitting element including the anode connected to the fourth and sixth transistors, and a cathode which receives a low power supply voltage.

According to some embodiments, the first transistor may further include a bottom gate connected to the source node, the second transistor may include a gate which receives the write signal, a first terminal connected to a data line, and a second terminal connected to the gate node, the third transistor may include a gate which receives the reference signal, a first terminal which receives the reference voltage, and a second terminal connected to the gate node, the fourth transistor may include a gate which receives the initialization signal, a first terminal connected to the anode of the light emitting element, and a second terminal which receives the initialization voltage, the fifth transistor may include a gate which receives the first emission signal, a first terminal which receives the corresponding one of the plurality of power supply voltages, and a second terminal connected to the drain of the driving transistor, and the sixth transistor may include a gate which receives the second emission signal, a first terminal connected to the source node, and a second terminal connected to the anode of the light emitting element.

According to some embodiments of the present disclosure, a method of operating a display device in which a display panel is divided into a plurality of panel regions. In the method, a plurality of power supply voltages is provided to the plurality of panel regions, respectively, input image data for the display panel are divided into a plurality of region image data for the plurality of panel regions, a target voltage level of each of the plurality of power supply voltages is determined by analyzing a corresponding one of plurality of region image data; and each of the plurality of power supply voltages is changed to the target voltage level in an end portion of an emission period for a corresponding one of the plurality of panel regions.

According to some embodiments of the present disclosure, an electronic device includes a processor configured to provide input image data, and a display device configured to display an image based on the input image data. According to some embodiments, the display device includes a display panel including a plurality of pixels, the display panel being divided into a plurality of panel regions, and a panel driver configured to drive the display panel based on input image data, and to provide a plurality of power supply voltages to the plurality of panel regions, respectively. According to some embodiments, the panel driver divides the input image data for the display panel into a plurality of region image data for the plurality of panel regions, determines a target voltage level of each of the plurality of power supply voltages by analyzing a corresponding one of plurality of region image data, and changes each of the plurality of power supply voltages to the target voltage level in an end portion of an emission period for a corresponding one of the plurality of panel regions.

As described above, in a display device and a method of operating the display device according to some embodiments, a plurality of power supply voltages may be respectively provided to a plurality of panel regions of a display panel, and a target voltage level of a power supply voltage for each panel region may be determined by analyzing region image data for the panel region. Further, the power supply voltage may be changed to the target voltage level in an end portion of an emission period for the panel region, and/or may be gradually changed to the target voltage level over a plurality of frame periods. Accordingly, power consumption of the display device may be relatively reduced while a luminance change is relatively reduced or minimized.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to some embodiments.

FIG. 2 is a diagram illustrating an example of a display panel included in a display device according to some embodiments.

FIG. 3 is a circuit diagram illustrating an example of a pixel included in a display device according to some embodiments.

FIG. 4 is a timing diagram for describing an example of an operation of a pixel of FIG. 3.

FIG. 5 is a circuit diagram for describing an example of an operation of a pixel of FIG. 3 in an initialization period.

FIG. 6 is a circuit diagram for describing an example of an operation of a pixel of FIG. 3 in a compensation period.

FIG. 7 is a circuit diagram for describing an example of an operation of a pixel of FIG. 3 in a write period.

FIG. 8 is a circuit diagram for describing an example of an operation of a pixel of FIG. 3 in an emission period.

FIG. 9 is a diagram illustrating an example of a gray-voltage lookup table included in a display device according to some embodiments.

FIG. 10A is a timing diagram for describing an example in which a power supply voltage is changed in a non-emission period, and FIGS. 10B and 10C are diagrams for describing examples of luminances of a pixel when the power supply voltage is changed at first through eighth time points within the non-emission period.

FIGS. 11A and 11B are timing diagrams for describing an example in which a power supply voltage is changed in an end portion of an emission period according to some embodiments, and FIGS. 11C and 11D are diagrams for describing examples of luminances of a pixel when the power supply voltage is changed at ninth and tenth points within the emission period.

FIG. 12 is a flowchart illustrating a method of operating a display device according to some embodiments.

FIG. 13 is a flowchart illustrating a method of operating a display device according to some embodiments.

FIG. 14 is a timing diagram for describing an example in which a power supply voltage is gradually changed in non-emission periods of a plurality of frame periods according to some embodiments.

FIG. 15 is a diagram illustrating examples of luminances of a pixel row when a power supply voltage is gradually changed at first through eighth time points within non-emission periods of a plurality of frame periods.

FIG. 16 is a flowchart illustrating a method of operating a display device according to some embodiments.

FIG. 17 is a timing diagram for describing an example in which a power supply voltage is gradually changed in end portions of emission periods of a plurality of frame periods according to some embodiments.

FIG. 18 is a block diagram illustrating an electronic device including a display device according to some embodiments.

### DETAILED DESCRIPTION

Hereinafter, aspects of some embodiments of the present disclosure will be explained in more detail with reference to the accompanying drawings.

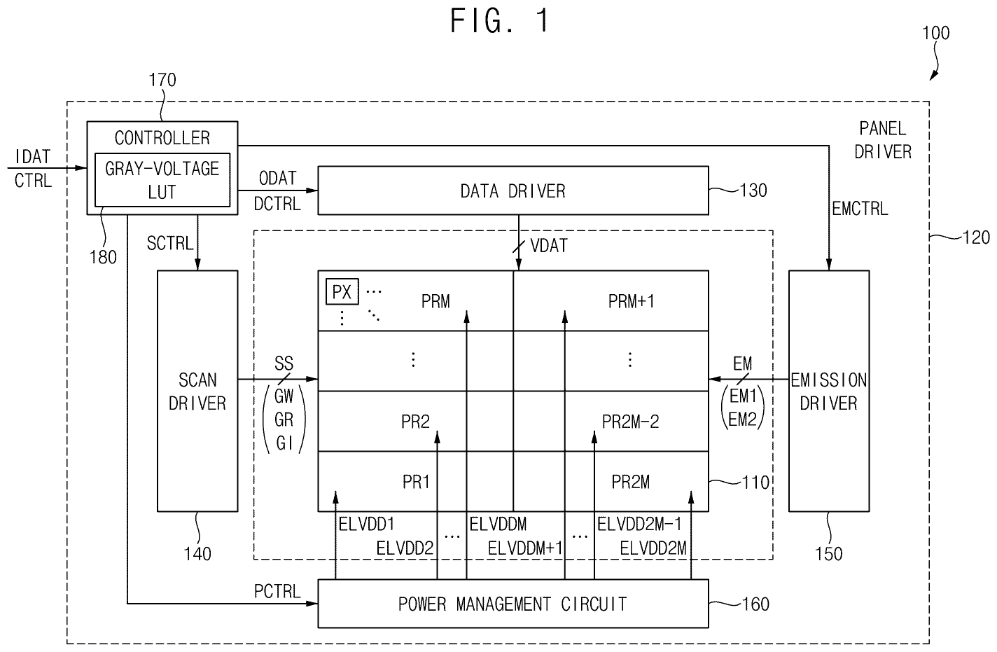

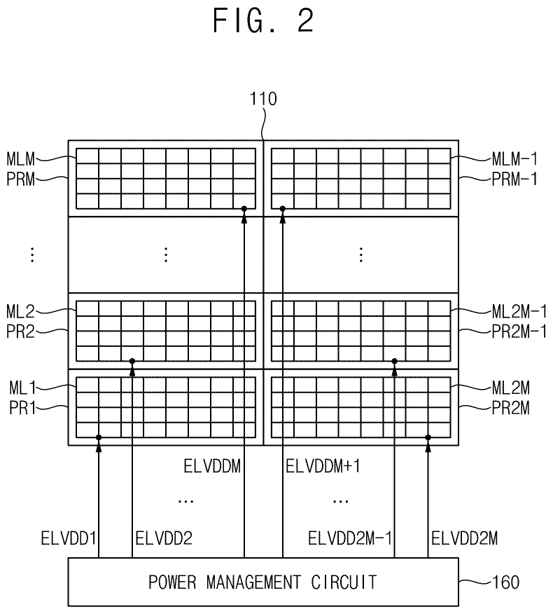

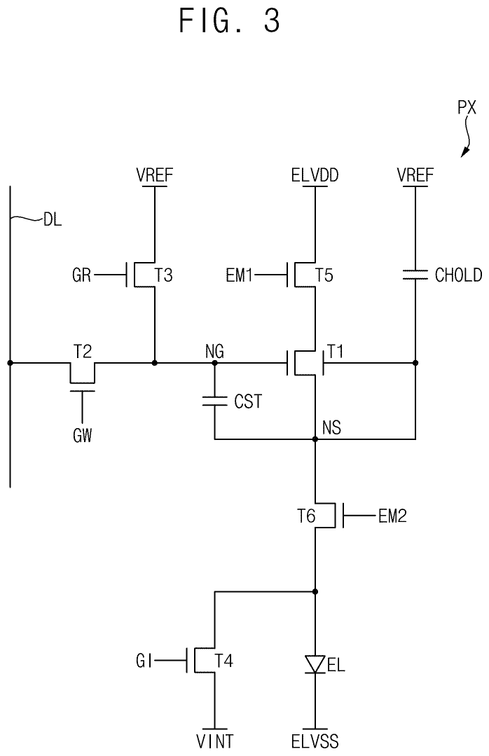

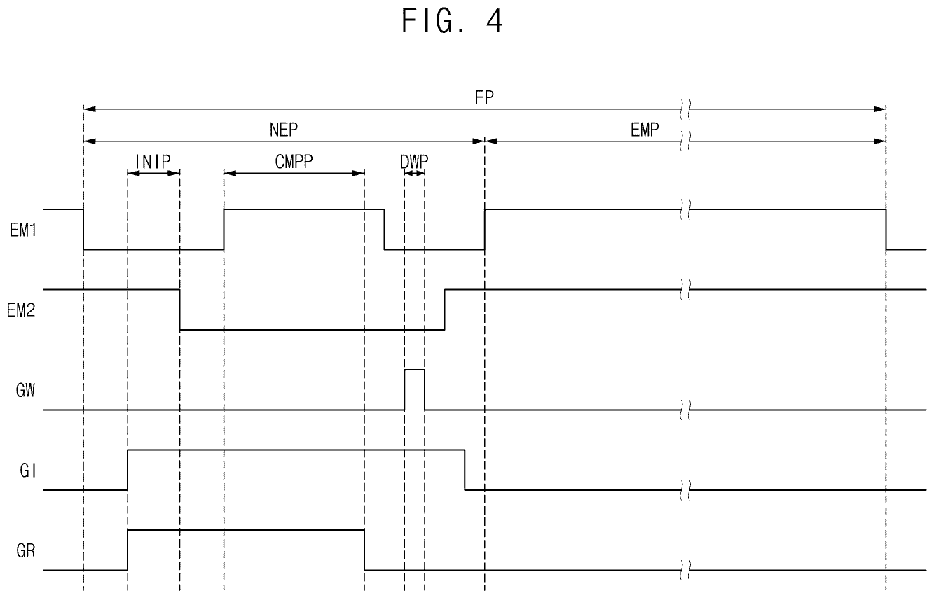

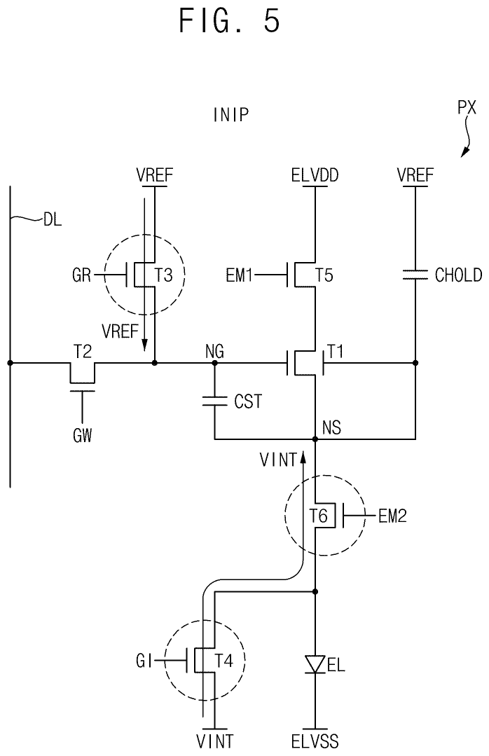

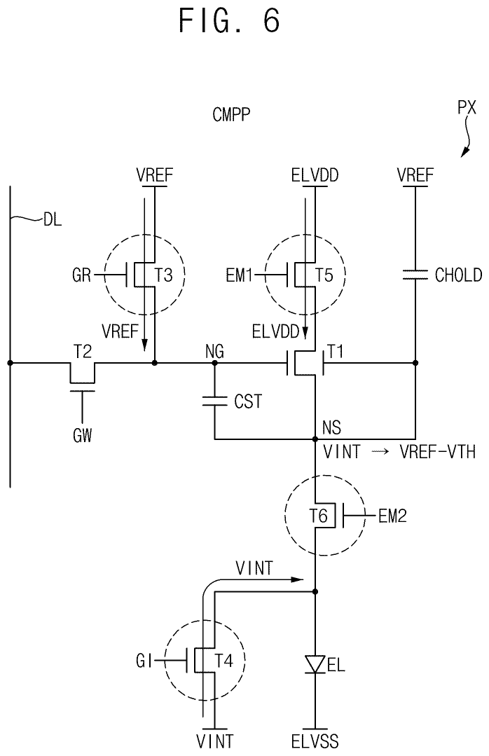

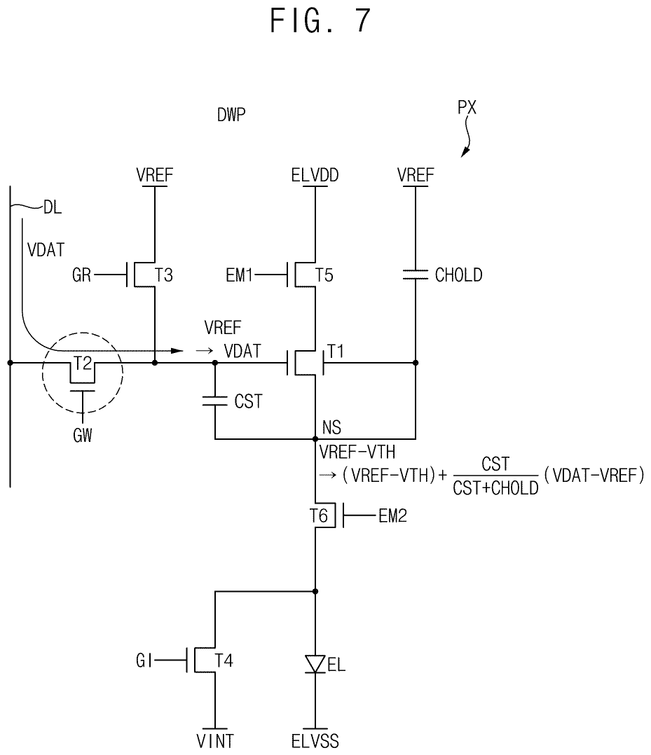

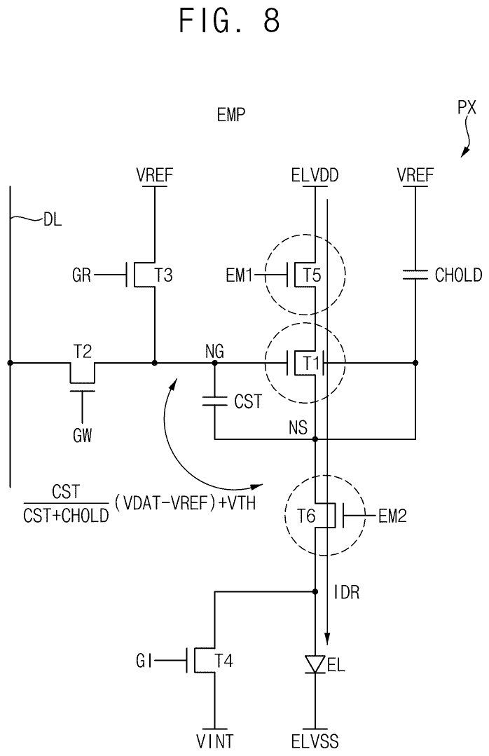

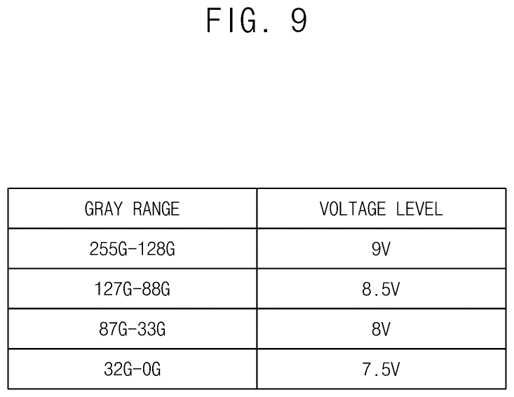

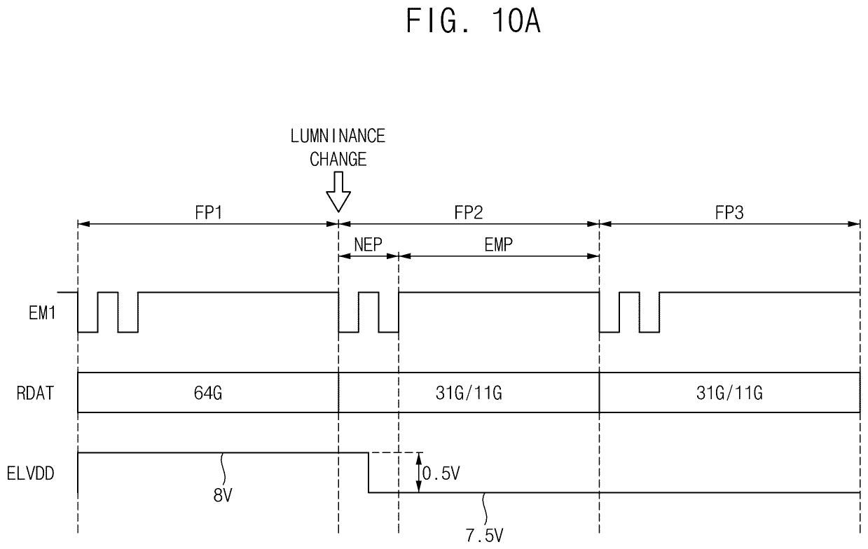

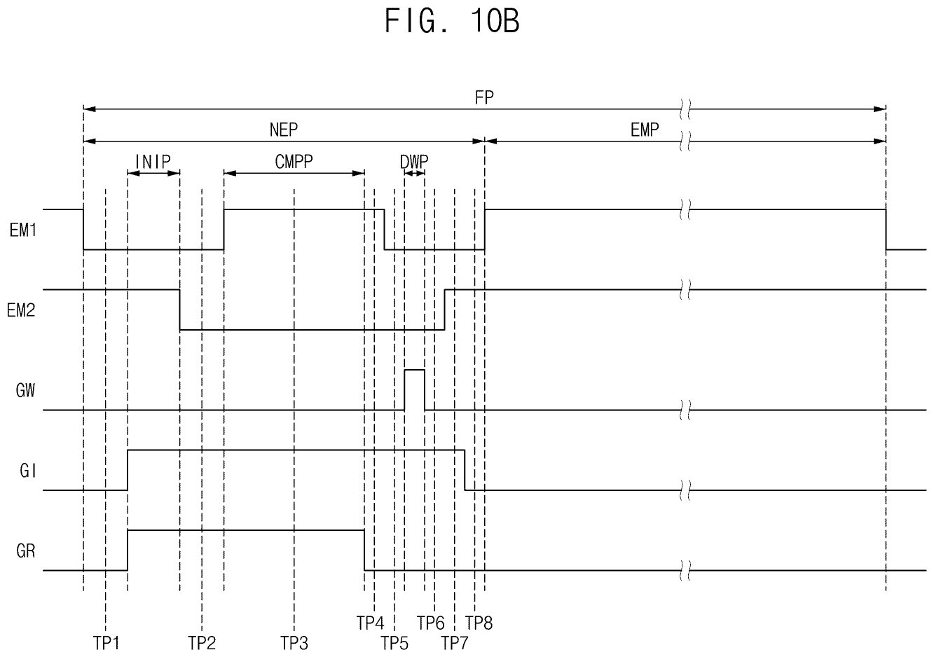

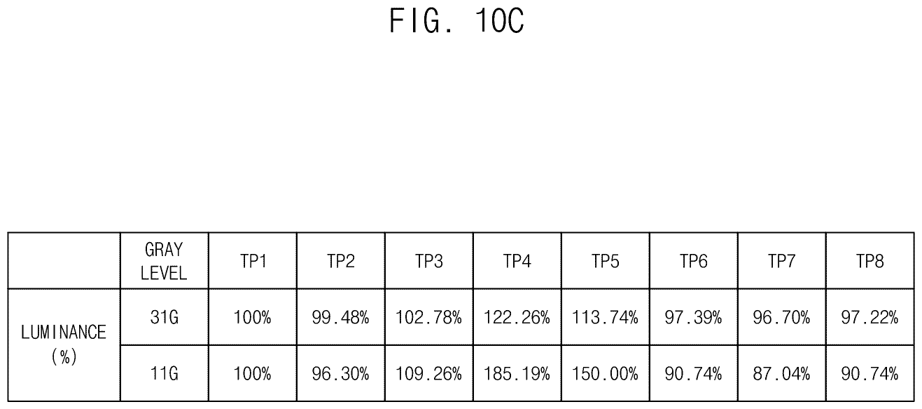

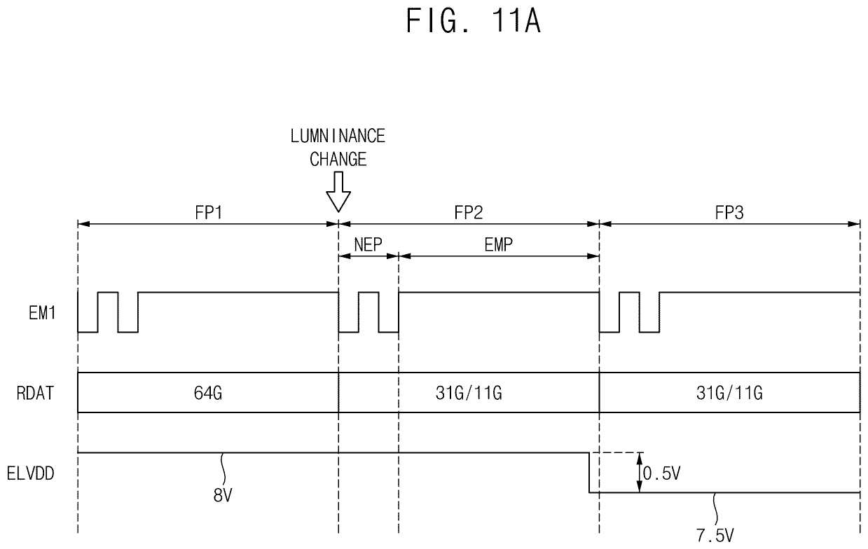

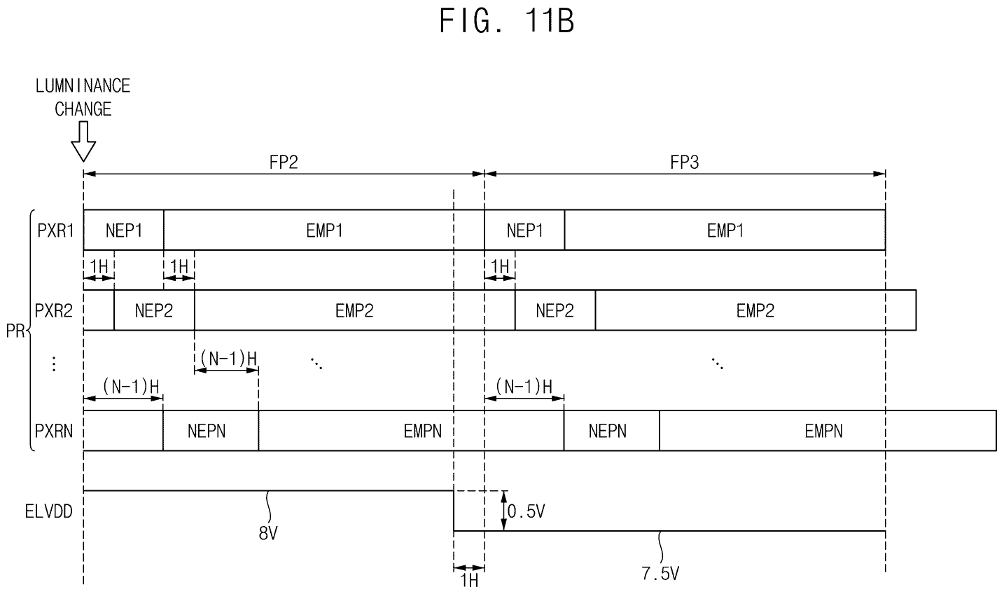

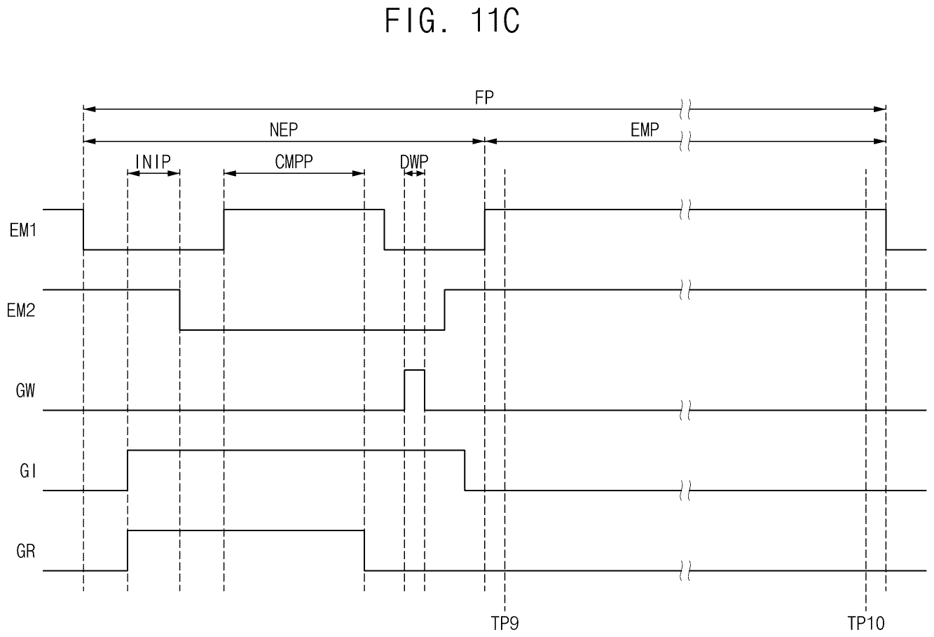

FIG. 1 is a block diagram illustrating a display device according to some embodiments, FIG. 2 is a diagram illustrating an example of a display panel included in a display device according to some embodiments, FIG. 3 is a circuit diagram illustrating an example of a pixel included in a display device according to some embodiments, FIG. 4 is a timing diagram for describing an example of an operation of a pixel of FIG. 3, FIG. 5 is a circuit diagram for describing an example of an operation of a pixel of FIG. 3 in an initialization period, FIG. 6 is a circuit diagram for describing an example of an operation of a pixel of FIG. 3 in a compensation period, FIG. 7 is a circuit diagram for describing an example of an operation of a pixel of FIG. 3 in a write period, FIG. 8 is a circuit diagram for describing an example of an operation of a pixel of FIG. 3 in an emission period, FIG. 9 is a diagram illustrating an example of a gray-voltage lookup table included in a display device according to some embodiments, FIG. 10A is a timing diagram for describing an example in which a power supply voltage is changed in a non-emission period, FIGS. 10B and 10C are diagrams for describing examples of luminances of a pixel when the power supply voltage is changed at first through eighth time points within the non-emission period, FIGS. 11A and 11B are timing diagrams for describing an example in which a power supply voltage is changed in an end portion of an emission period according to some embodiments, and FIGS. 11C and 11D are diagrams for describing examples of luminances of a pixel when the power supply voltage is changed at ninth and tenth points within the emission period.

Referring to FIG. 1, a display device 100 may include a display panel 110 that includes a plurality of pixels PX, and a panel driver 120 that drives the display panel 110 based on input image data IDAT. According to some embodiments, the panel driver 120 may include a data driver 130 that provides data voltages VDAT to the plurality of pixels PX, a scan driver 140 that provides scan signals SS to the plurality of pixels PX, an emission driver 150 that provides emission signals EM to the plurality of pixels PX, a power management circuit 160 that provides a plurality of power supply voltages ELVDD1, ELVDD2, . . . , ELVDDM, ELVDDM+1, . . . , ELVDD2M−1 and ELVDD2M (e.g., a plurality of high power supply voltages) to a plurality of panel regions PR1, PR2, . . . , PRM, PRM+1, . . . , PR2M−1 and PR2M of the display panel 110, and a controller 170 that controls the data driver 130, the scan driver 140, the emission driver 150 and the power management circuit 160.

The display panel 110 may include a plurality of data lines, a plurality of scan lines, a plurality of emission lines, and the plurality of pixels PX connected thereto. Further, the display panel 110 may be divided into a plurality of panel regions PR1, PR2, PRM, PRM+1, . . . , PR2M−1 and PR2M, each of which includes the plurality of pixels . . . ,

PX. The plurality of panel regions PR1, PR2, . . . , PRM, PRM+1, . . . , PR2M−1 and PR2M may receive the plurality of power supply voltages ELVDD1, ELVDD2, . . . , ELVDDM, ELVDDM+1, . . . , ELVDD2M−1 and ELVDD2M, respectively. For example, as illustrated in FIGS. 1 and 2, a left half of the display panel 110 may be divided into M panel regions PR1, PR2, . . . , and PRM, where M is an integer greater than 0, and a right half of the display panel 110 may be divided into other M panel regions PRM+1, . . . , PR2M−1 and PR2M, but is not limited thereto.

According to some embodiments, as illustrated in FIG. 2, the plurality of panel regions PR1, PR2, . . . , PRM, PRM+1, . . . , PR2M−1 and PR2M may include a plurality of mesh lines ML1, ML2, . . . , MLM, MLM+1, . . . , ML2M−1 and ML2M, respectively, and the plurality of mesh lines ML1, ML2, . . . , MLM, MLM+1, . . . , ML2M−1 and ML2M may be spaced apart or electrically disconnected from each other. For example, each mesh line ML1 through ML2M may include a plurality of vertical lines extending in a vertical direction (e.g., a pixel column direction or a direction in which a data line is extended) and a plurality of horizontal lines extending in a horizontal direction (e.g., a pixel row direction or in a direction in which a scan line is extended), and the plurality of vertical lines and the plurality of horizontal lines may be connected to each other. The plurality of mesh lines ML1, ML2, . . . , MLM, MLM+1, . . . , ML2M−1 and ML2M may respectively receive the plurality of power supply voltages ELVDD1, ELVDD2, . . . , ELVDDM, ELVDDM+1, . . . , ELVDD2M−1 and ELVDD2M from the power management circuit 160 of the panel driver 120. Further, each mesh line ML1 through ML2M may be connected to the plurality of pixels PX included in a corresponding panel region, and may transfer a corresponding one of the plurality of power supply voltages ELVDD1 through ELVDD2M received from the power management circuit 160 to the plurality of pixels PX. For example, a first mesh line ML1 may provide a first power supply voltage ELVDD1 to the pixels PX in a first panel region PR1, a second mesh line ML2 may provide a second power supply voltage ELVDD2 to the pixels PX in a second panel region PR2, an M-th mesh line MLM may provide an M-th power supply voltage ELVDDM to the pixels PX in an M-th panel region PRM, an (M+1)-th mesh line MLM+1 may provide an (M+1)-th power supply voltage ELVDDM+1 to the pixels PX in an (M+1)-th panel region PRM+1, a (2M−1)-th mesh line ML2M-1 may provide a (2M−1)-th power supply voltage ELVDD2M-1 to the pixels PX in a (2M−1)-th panel region PR2M-1, and a 2M-th mesh line ML2M may provide a 2M-th power supply voltage ELVDD2M to the pixels PX in a 2M-th panel region PR2M.

Each panel region PR1 through PR2M of the display panel 110 may include the plurality of pixels PX. According to some embodiments, as illustrated in FIG. 3, each pixel PX may include a first transistor T1, a second transistor T2, a third transistor T3, a fourth transistor T4, a fifth transistor T5, a sixth transistor T6, a storage capacitor CST, a hold capacitor CHOLD and a light emitting element EL.

The first transistor T1 may generate a driving current provided to the light emitting element EL based on a voltage between a gate node NG and a source node NS, or a voltage stored between first and second electrodes of the storage capacitor CST. According to some embodiments, the first transistor T1 may include a gate connected to the gate node NG, a drain connected to the fifth transistor T5, and a source connected to the source node NS.

According to some embodiments, the gate connected to the gate node NG may be a top gate located above an active layer of the first transistor T1, and the first transistor T1 may further include a bottom gate located under the active layer. That is, the first transistor T1 may have a double gate structure including the top gate and the bottom gate. According to some embodiments, the bottom gate may be referred to as a bottom metal layer. The bottom gate of the first transistor T1 may be connected to the source node NS, a voltage of the bottom gate may be maintained or held by the hold capacitor CHOLD, and thus a driving characteristic of the first transistor T1 may be relatively improved.

The second transistor T2 may transfer a data voltage to the gate node NG in response to a write signal GW. According to some embodiments, the second transistor T2 may include a gate which receives the write signal GW, a first terminal connected to a data line DL, and a second terminal connected to the gate node NG.

The third transistor T3 may transfer a reference voltage VREF to the gate node NG in response to a reference signal GR. According to some embodiments, the third transistor T3 may include a gate which receives the reference signal GR, a first terminal which receives the reference voltage VREF, and a second terminal connected to the gate node NG.

The fourth transistor T4 may transfer an initialization voltage VINT to an anode of the light emitting element EL in response to an initialization signal GI. According to some embodiments, the fourth transistor T4 may include a gate which receives the initialization signal GI, a first terminal connected to the anode of the light emitting element EL, and a second terminal which receives the initialization voltage VINT.

The fifth transistor T5 may transfer a power supply voltage ELVDD (e.g., a high power supply voltage) to the drain of the first transistor T1 in response to a first emission signal EM1. Here, the power supply voltage ELVDD may be a corresponding one of the plurality of power supply voltages ELVDD1 through ELVDD2M received from the power management circuit 160. For example, the power supply voltage ELVDD may be the first power supply voltage ELVDD1 in a case where the pixel PX is located in the first panel region PR1. According to some embodiments, the power supply voltage ELVDD may be the second power supply voltage ELVDD2 in a case where the pixel PX is located in the second panel region PR2. According to some embodiments, the power supply voltage ELVDD may be the 2M-th power supply voltage ELVDD2M in a case where the pixel PX is located in the 2M-th panel region PR2M. According to some embodiments, the fifth transistor T5 may include a gate which receives the first emission signal EM1, a first terminal which receives the power supply voltage ELVDD, and a second terminal connected to the drain of the first transistor T1.

The sixth transistor T6 may connect the source node NS to the anode of the light emitting element EL in response to a second emission signal EM2. According to some embodiments, the sixth transistor T6 may include a gate which receives the second emission signal EM2, a first terminal connected to the source node NS, and a second terminal connected to the anode of the light emitting element EL.

The hold capacitor CHOLD may be connected between a line which transfers the reference voltage VREF and the source node NS. According to some embodiments, the hold capacitor CHOLD may include a first electrode which receives the reference voltage VREF, and a second electrode connected to the source node NS.

The light emitting element EL may emit light based on the driving current generated by the first transistor T1. According to some embodiments, the light emitting element EL may be, but is not limited to, an organic light emitting diode (“OLED”).

According to some embodiments, the light emitting element EL may be any suitable light emitting element. For example, the light emitting element EL may be a nano light emitting diode (“NED”), a quantum dot (“QD”) light emitting diode, a micro light emitting diode, an inorganic light emitting diode, or any other suitable light emitting element. According to some embodiments, the light emitting element EL may include the anode connected to the third and fifth transistors T3 and T5, and a cathode which receives a low power supply voltage ELVSS.

According to some embodiments, at least one of the first through sixth transistors T1 through T6 may be implemented as an N-type metal oxide semiconductor (“NMOS”) transistor, but is not limited thereto. For example, as illustrated in FIG. 3, all of the first through sixth transistors T1 through T6 may be implemented as NMOS transistors. According to some embodiments, some or all of the first through sixth transistors T1 through T6 may be P-type metal oxide semiconductor (“PMOS”) transistors.

Although FIG. 3 illustrates an example in which the pixel PX has a 6T2C structure, the pixel PX of the display device 100 according to some embodiments is not limited to the example of FIG. 3, and may have any structure. For example, according to various embodiments, the pixel PX may include additional components or fewer components without departing from the spirit and scope of embodiments according to the present disclosure. Hereinafter, with reference to FIGS. 3 to 8, an example of an operation of the pixel PX of the display device 100 according to some embodiments is described below.

Referring to FIGS. 3 and 4, each frame period FP may include a non-emission period NEP in which the light emitting element EL does not emit light, and an emission period EMP in which the light emitting element EL emits light. According to some embodiments, the non-emission period NEP may include an initialization period INIP in which the gate node NG and the source node NS are initialized, a compensation period CMPP in which a threshold voltage of the first transistor T1 is stored in the storage capacitor CST, and a write period DWP in which the data voltage VDAT is transferred to the gate node NG.

In the initialization period INIP, the first emission signal EM1 may have a low level, the second emission signal EM2 may have a high level, the write signal GW may have the low level, the initialization signal GI may have the high level, and the reference signal GR may have the high level. As illustrated in FIG. 5, the third transistor T3 may be turned on in response to the reference signal GR having the high level to apply the reference voltage VREF to the gate node NG. Further, the fourth transistor T4 may be turned on in response to the initialization signal GI having the high level, and the sixth transistor T6 may be turned on in response to the second emission signal EM2 having the high level, and thus the initialization voltage VINT may be applied to the source node NS through the fourth transistor T4 and the sixth transistor T6. Accordingly, the gate node NG may be initialized based on the reference voltage VREF, and the source node NS may be initialized based on the initialization voltage VINT. Further, the initialization voltage VINT may be applied to the anode of the light emitting element EL, and thus the anode of the light emitting element EL may be initialized based on the initialization voltage VINT.

In the compensation period CMPP, the first emission signal EM1 may have the high level, the second emission signal EM2 may have the low level, the write signal GW may have the low level, the initialization signal GI may have the low level, and the reference signal GR may have the high level. As illustrated in FIG. 6, the third transistor T3 may be turned on based on the reference signal GR having the high level, and may continue to apply the reference voltage VREF to the gate node NG. The fifth transistor T5 may be turned on based on the first emission signal EM1 having the high level, and may apply the power supply voltage ELVDD to the drain of the first transistor T1. The sixth transistor T6 may be turned off in response to the second emission signal EM2 having the low level. Thus, the first transistor T1 may be turned on based on the reference voltage VREF applied to its gate, and may operate as a source follower that changes a voltage of its source to a voltage close to the reference voltage VREF. That is, the first transistor T1 may be turned on until a threshold voltage VTH of the first transistor T1 is stored in the storage capacitor CST, or until the voltage of the source node NS becomes a voltage VREF-VTH obtained by subtracting the threshold voltage VTH from the reference voltage VREF. Thus, the voltage of the source node NS may be changed from the initialization voltage VINT to the voltage VREF-VTH obtained by subtracting the threshold voltage VTH from the reference voltage VREF. Further, the fourth transistor T4 may be turned on in response to the initialization signal GI having the high level to apply the initialization voltage VINT to the anode of the light emitting element EL, and thus the anode of the light emitting element EL may be initialized based on the initialization voltage VINT.

In the write period DWP, the first emission signal EM1 may have the low level, the second emission signal EM2 may have the low level, the write signal GW may have the high level, the initialization signal GI may have the low level, and the reference signal GR may have the low level. As illustrated in FIG. 7, the second transistor T2 may be turned on in response to the write signal GW having the high level to apply the data voltage VDAT to the gate node NG. Thus, the voltage of the gate node NG may be changed from the reference voltage VREF to the data voltage VDAT by “VDAT−VREF”.

If the voltage of the gate node NG is changed by “VDAT−VREF”, the voltage of the source node NS also may be changed by

$$“ \frac{CST}{CST + CHOLD} ( V DAT - V REF ) ”$$

based on a change of the voltage of the gate node NG and the storage and hold capacitors CST and CHOLD. Thus, the voltage of the source node NS may be changed from “VREF−VTH” to

$$“ ( V REF - V TH ) + \frac{CST}{CST + CHOLD} ( V DAT - V REF ) ” .$$

Accordingly, a gate-source voltage of the first transistor T1 may become

$$“ \frac{CHOLD}{CST + CHOLD} ( V DAT - V REF ) + V TH ” .$$

In the emission period EMP, the first emission signal EM1 may have the high level, the second emission signal EM2 may have the high level, the write signal GW may have the low level, the initialization signal GI may have the low level, and the reference signal GR may have the low level. As illustrated in FIG. 8, the fifth and sixth transistors T5 and T6 may be turned on in response to the first and second emission signals EM1 and EM2 having the high level, and the first transistor T1 may be turned on based on the voltage stored in the storage capacitor CST, or

$$“ \frac{CHOLD}{CST + CHOLD} ( V DAT - V REF ) + V TH ” ,$$

to provide the driving current IDR to the light emitting element EL. The light emitting element EL may emit light based on the driving current IDR.

Referring again to FIG. 1, the data driver 130 may generate the data voltages VDAT based on output image data ODAT and a data control signal DCTRL received from the controller 170, and may provide the data voltages VDAT to the plurality of pixels PX through the plurality of data lines. According to some embodiments, the data control signal DCTRL may include, but is not limited to, an output data enable signal, a horizontal start signal, and a load signal. According to some embodiments, the data driver 130 and the controller 170 may be implemented as a single integrated circuit, and the single integrated circuit may be referred to as a timing controller embedded data driver (“TED”) integrated circuit. According to some embodiments, the data driver 130 and the controller 170 may be implemented as separate integrated circuits.

The scan driver 140 may generate the scan signals SS based on a scan control signal SCTRL received from the controller 170, and may sequentially provide the scan signals SS to the plurality of pixels PX through the plurality of scan lines on a row-by-row basis. According to some embodiments, the scan control signal SCTRL may include, but is not limited to, a scan start signal, a scan clock signal, etc. Further, according to some embodiments, the scan signals SS applied to each pixel PX may include, but is not limited to, the write signal GW, the reference signal GR and the initialization signal GI illustrated in FIGS. 3 and 4. According to some embodiments, the scan driver 140 may be integrated or formed in the display panel 110. According to some embodiments, the scan driver 140 may be implemented with one or more integrated circuits.

The emission driver 150 may generate the emission signals EM based on an emission control signal EMCTRL received from the controller 170, and may sequentially provide the emission signals EM to the plurality of pixels PX through the plurality of emission lines on a row-by-row basis. According to some embodiments, the emission control signal EMCTRL may include, but is not limited to, an emission start signal, an emission clock signal, etc. Further, according to some embodiments, the emission signals EM applied to each pixel PX may include, but is not limited to, the first and second emission signals EM1 and EM2 illustrated in FIGS. 3 and 4. According to some embodiments, the emission driver 150 may be integrated or formed in the display panel 110. According to some embodiments, the emission driver 150 may be implemented with one or more integrated circuits.

The power management circuit 160 may generate voltages for an operation of the display device 100 based on a power control signal PCTRL received from the controller 170. For example, the power management circuit 160 may generate the plurality of power supply voltages ELVDD1, ELVDD2, . . . , ELVDDM, ELVDDM+1, . . . , ELVDD2M-1 and ELVDD2M (e.g., high power supply voltages), the low power supply voltage ELVSS, the reference voltage VREF and the initialization voltage VINT provided to the display panel 110. Further, the power management circuit 160 may generate the plurality of power supply voltages ELVDD1, ELVDD2, . . . , ELVDDM, ELVDDM+1, . . . , ELVDD2M-1 and ELVDD2M for the plurality of panel regions PR1, PR2, . . . , PRM, PRM+1, . . . , PR2M−1 and PR2M, and may provide the plurality of power supply voltages ELVDD1, ELVDD2, . . . , ELVDDM, ELVDDM+1, . . . , ELVDD2M−1 and ELVDD2M to the plurality of mesh lines ML1, ML2, . . . , MLM, MLM+1, . . . , ML2M−1 and ML2M of the plurality of panel regions PR1, PR2, . . . , PRM, PRM+1, . . . , PR2M−1 and PR2M, respectively. According to some embodiments, the power management circuit 160 may be implemented as a power management integrated circuit (“PMIC”), but is not limited thereto. According to some embodiments, the power management circuit 160 may be included in the controller 170 and/or the data driver 130.

The controller 170 (e.g., a timing controller) may receive the input image data IDAT and a control signal CTRL from an external processor (e.g., a graphics processing unit (“GPU”), an application processor (“AP”) or a graphics card). According to some embodiments, the control signal CTRL may include, but is not limited to, a vertical synchronization signal, a horizontal synchronization signal, an input data enable signal, a master clock signal, etc. The controller 170 may generate the output image data ODAT, the data control signal DCTRL, the scan control signal SCTRL, the emission control signal EMCTRL and the power control signal PCTRL based on the input image data IDAT and the control signal CTRL. The controller 170 may control the data driver 130 by providing the output image data ODAT and the data control signal DCTRL to the data driver 130, may control the scan driver 140 by providing the scan control signal SCTRL to the scan driver 140, may control the emission driver 150 by providing the emission control signal EMCTRL to the emission driver 150, and may control the power management circuit 160 by providing the power control signal PCTRL to the power management circuit 160.

In the display device 100 according to some embodiments, the controller 170 of the panel driver 120 may divide the input image data IDAT for the display panel 110 into a plurality of region image data for the plurality of panel regions PR1 through PR2M, and may determine target voltage levels of the plurality of power supply voltages ELVDD1 through ELVDD2M for the plurality of panel regions PR1 through PR2M by analyzing the plurality of region image data for the plurality of panel regions PR1 through PR2M, respectively. According to some embodiments, with respect to each panel region, the controller 170 may calculate an average gray level of a plurality of gray levels represented by a plurality of pixel data included in the region image data for the panel region, and may determine the target voltage level of the power supply voltage ELVDD for the panel region based on the average gray level. For example, the controller 170 may determine a target voltage level of the first power supply voltage ELVDD1 for the first panel region PR1 based on an average gray level of a plurality of gray levels represented by a plurality of pixel data for the pixels PX included in the first panel region PR1, and may determine a target voltage level of the 2M-th power supply voltage ELVDD2M for the 2M-th panel region PR2M based on an average gray level of a plurality of gray levels represented by a plurality of pixel data for the pixels PX included in the 2M-th panel region PR2M.

According to some embodiments, to determine the target voltage level of the power supply voltage ELVDD for each panel region based on the average gray level for the panel region, the controller 170 may include a gray-voltage lookup table 180 that stores a plurality of voltage levels respectively corresponding to a plurality of gray ranges. For example, as illustrated in FIG. 9, the gray-voltage lookup table 180 may store a voltage level of about 9 V for a first gray range from a 255-gray level 255G to a 128-gray level 128G, a voltage level of about 8.5 V for a second gray range from a 127-gray level 127G to a 88-gray level 88G, a voltage level of about 8 V for a third gray range from a 87-gray level 87G to a 33-gray level 33G, and a voltage level of about 7.5 V for a fourth gray range from a 32-gray level 32G to a 0-gray level 0G, but is not limited thereto. Further, the controller 170 may receive a voltage level corresponding to a gray range to which the average gray level belongs among the plurality of gray ranges from the gray-voltage lookup table 180, and may determine the target voltage level of a corresponding power supply voltage ELVDD as the voltage level received from the gray-voltage lookup table 180. For example, when the average gray level for the first panel region PR1 is a 200 gray-level within the first gray range, the target voltage level of the first power supply voltage ELVDD1 for the first panel region PR1 may be determined as about 9 V. Further, when the average gray level for the second panel region PR2 is a 100 gray-level within the second gray range, the target voltage level of the second power supply voltage ELVDD2 for the second panel region PR2 may be determined as about 8.5 V. Further, when the average gray level for the M-th panel region PRM is a 60 gray-level within the third gray range, the target voltage level of the M-th power supply voltage ELVDDM for the M-th panel region PRM may be determined as about 8 V. Further, when the average gray level for the 2M-th panel region PR2M is a 20 gray-level within the fourth gray range, the target voltage level of the 2M-th power supply voltage ELVDD2M for the 2M-th panel region PR2M may be determined as about 7.5 V.

As described above, the controller 170 may determine the target voltage levels of the plurality of power supply voltages ELVDD1 through ELVDD2M for the plurality of panel regions PR1 through PR2M, and the power management circuit 160) may provide the plurality of power supply voltages ELVDD1 through ELVDD2M having the target voltage levels to the plurality of panel regions PR1 through PR2M, respectively. Accordingly, even if some panel regions among the plurality of panel regions PR1 through PR2M display a high luminance image (or a high gray image), the power supply voltages ELVDD of other panel regions that display a low luminance image (or a low gray image) among the plurality of panel regions PR1 through PR2M may be decreased, power consumption of the display device 100 according to some embodiments may be relatively reduced.

It may be considered that the power supply voltage ELVDD for each panel region is changed to the target voltage level in the non-emission period NEP for the panel region. For example, as illustrated in FIG. 10A, in a case where the average gray level of the region image data RDAT for the panel region is a 64-gray level 64G within the third gray range in a first frame period FP1, and is a 31-gray level 31G or a 11-gray level 11G within the fourth gray range in second and third frame periods FP2 and FP3, the power supply voltage ELVDD may be decreased by about 0.5 V from about 8 V corresponding to the third gray range to about 7.5 V corresponding to the fourth gray range in the non-emission period NEP of the second frame period FP2 in which a luminance or the average gray level is changed. Meanwhile, each panel region may include the pixels PX arranged in first through N-th pixel rows, where N is an integer greater than 1, and the non-emission periods NEP for the first through N-th pixel rows may be shifted by one horizontal time per each pixel row. Here, one horizontal time may correspond to a time obtained by dividing each frame period FP1, FP2 and FP3 by the number of the pixel rows of the display panel 110. Since the non-emission periods NEP for the first through N-th pixel rows are shifted by one horizontal time per each pixel row, in the same panel region, time points at which the power supply voltage ELVDD for the panel region is changed may have different positions within the non-emission periods NEP for the first through N-th pixel rows. For example, in a case where the power supply voltage ELVDD is changed to the target voltage level at an end time point of the non-emission period NEP for the first pixel row that is the uppermost pixel row among the first through N-th pixel rows, with respect to a second pixel row that is next to the first pixel row, the power supply voltage ELVDD may be changed to the target voltage level one horizontal time before an end time point of the non-emission period NEP for the second pixel row. Further, in this case, with respect to a third pixel row that is next to the second pixel row, the power supply voltage ELVDD may be changed to the target voltage level two horizontal times before an end time point of the non-emission period NEP for the third pixel row.

Further, as illustrated in FIGS. 10B and 10C, in a case where the power supply voltage ELVDD is changed from about 8 V to about 7.5 V at a first time point TP1 before the initialization period INIP of the non-emission period NEP, each pixel PX may emit light with a luminance of about 100%, which is the same as a luminance of the pixel PX in a case where the power supply voltage ELVDD has already been changed before the frame period FP, or a desired luminance. However, in a case where the power supply voltage ELVDD is changed at a second time point TP2 between the initialization period INIP and the compensation period CMPP of the non-emission period NEP, the pixel PX driven based on pixel data representing the 31-gray level 31G may emit light with a luminance of about 99.48% in the frame period FP, and the pixel PX driven based on pixel data representing the 11-gray level 11G may emit light with a luminance of about 96.30% in the frame period FP. Further, in cases where the power supply voltage ELVDD is changed at a third time point TP3 within the compensation period CMPP, a fourth time point TP4 between the compensation period CMPP and the write period DWP, a fifth time point TP5 after the fourth time point TP4 and before the write period DWP, a sixth time point TP6 after the write period DWP, a seventh time point TP7 after the sixth time point TP6 and an eighth time point TP8 after the seventh time point TP7, in the frame period FP, the pixel PX corresponding to the 31-gray level 31G may have a luminance of about 102.78%, a luminance of about 122.26%, a luminance of about 113.74%, a luminance of about 97.39%, a luminance of about 96.70% and a luminance of about 97.22%, respectively, and the pixel PX corresponding to the 11-gray level 11G may have a luminance of about 109.26%, a luminance of about 185.19%, a luminance of about 150.00%, a luminance of about 90.74%, a luminance of about 87.04% and a luminance of about 90.74%, respectively. That is, in the case where the power supply voltage ELVDD is changed from about 8 V to about 7.5 V at the fourth time point TP4 after the compensation period CMPP and when the first emission signal EM1 has the high level, the power supply voltage ELVDD applied to the drain of the first transistor T1 may be decreased, and a source voltage of the first transistor T1 also may be decreased due to a parasitic capacitor between the drain and the source of the first transistor T1. Thus, in this case, the gate-source voltage of the first transistor T1 may be increased, and the luminance of the pixel PX may be undesirably increased.

Accordingly, as illustrated in FIGS. 10A to 10C, in the case where the power supply voltage ELVDD for each panel region is changed to the target voltage level in the non-emission period NEP for the panel region (e.g., in a period in which the non-emission periods NEP for the first through N-th pixel rows included in the panel region overlap each other), the time point at which the power supply voltage ELVDD is changed may have different positions within the respective non-emission periods NEP for the first through N-th pixel rows, and the pixels PX in the first through N-th pixel rows may have different luminances. That is, in this case, the first through N-th pixel rows within the same panel region may have a luminance deviation.

In order to relatively reduce or minimize the luminance deviation or a luminance change, in the display device 100 according to some embodiments, the panel driver 120 may change the power supply voltage ELVDD for each panel region to the target voltage level in an end portion of the emission period EMP for the panel region. Here, the end portion of the emission period EMP may be a portion from a certain point in time after the middle point of the emission period EMP to the end point of the emission period EMP, but is not limited thereto. For example, as illustrated in FIG. 11A, in a case where the average gray level of the region image data RDAT for a panel region changes from the 64-gray level 64G to the 31-gray level 31G or the 11-gray level 11G in the second frame period FP2, the panel driver 120 may decrease the power supply voltage ELVDD for the panel region by about 0.5 V from about 8 V to about 7.5 V that is the target voltage level in an end portion of the emission period EMP within the second frame period FP2.

According to some embodiments, as illustrated in FIG. 11B, the non-emission periods NEP1, NEP2, . . . , and NEPN for the first through N-th pixel rows PXR1, PXR2, . . . , and PXRN included in the same panel region PR may be shifted by one horizontal time 1H per each pixel row, and the emission periods EMP1, EMP2, . . . , and EMPN for the first through N-th pixel rows PXR1, PXR2, . . . , and PXRN included in the same panel region PR also may be shifted by one horizontal time 1H per each pixel row. For example, a second emission period EMP2 for the second pixel row PXR2 may be delayed by one horizontal time 1H from a first emission period EMP1 for the first pixel row PXR1, and an N-th emission period EMPN for the N-th pixel row PXRN may be delayed by N−1 horizontal times (N−1)H from the first emission period EMP1 for the first pixel row PXR1. According to some embodiments, the panel driver 120 may change the power supply voltage ELVDD for the panel region PR including the first through N-th pixel rows PXR1, PXR2, . . . , and PXRN to the target voltage level within a period in which the first through N-th emission periods EMP1, EMP2, . . . , and EMPN for the first through N-th pixel rows PXR1, PXR2, . . . , and PXRN included in the same panel region PR overlap each other. For example, as illustrated in FIG. 11B, the panel driver 120 may change the power supply voltage ELVDD for the panel region PR to the target voltage level one horizontal time 1H before an end time point of the emission period EMP1 for the first pixel row PXR1 that is the uppermost pixel row among the first through N-th pixel rows PXR1, PXR2, . . . , and PXRN included in the same panel region PR.

Further, as illustrated in FIGS. 11C and 11D, in a case where the power supply voltage ELVDD is changed from about 8 V to about 7.5 V at a ninth time point TP9 within an initial portion of the non-emission period NEP, the pixel PX driven based on the pixel data representing the 31-gray level 31G may emit light with a luminance of about 96.70% in the frame period FP, and the pixel PX driven based on the pixel data representing the 11-gray level 11G may emit light with a luminance of about 87.04% in the frame period FP. Further, in a case where the power supply voltage ELVDD is changed from about 8 V to about 7.5 V at a tenth time point TP10 within the end portion of the non-emission period NEP, the pixel PX driven based on the pixel data representing the 31-gray level 31G may emit light with a luminance of about 101.91% in the frame period FP, and the pixel PX driven based on the pixel data representing the 11-gray level 11G may emit light with a luminance of about 105.56% in the frame period FP. Thus, as illustrated in FIGS. 10C and 11D, the luminance deviation or the luminance change in the case where the power supply voltage ELVDD is changed to the target voltage level at the tenth time point T10 within the end portion of the emission period EMP may be relatively reduced compared to the luminance deviation or luminance change in the cases where the power supply voltage ELVDD is changed to the target voltage level at the first through ninth time points T1 through T9.

Accordingly, as illustrated in FIGS. 10A to 10C, in the case where the power supply voltage ELVDD for each panel region is changed to the target voltage level in the non-emission period NEP for the panel region (e.g., in the period in which the non-emission periods NEP for the first through N-th pixel rows included in the panel region overlap each other), the time point at which the power supply voltage ELVDD is changed may have different positions within the non-emission periods NEP for the first through N-th pixel rows, and the pixels PX in the first through N-th pixel rows may have different luminances. That is, in this case, the first through N-th pixel rows within the same panel region may have the luminance deviation. However, in the display device 100 according to some embodiments, as illustrated in FIGS. 11A through 11D, the panel driver 120 may change the power supply voltage ELVDD for each panel region PR to the target voltage level in the end portion of the emission period EMP for the panel region PR, thereby relatively reducing or minimizing the luminance deviation or the luminance change caused by the voltage change of the power supply voltage ELVDD.

As described above, in the display device 100 according to some embodiments, the plurality of power supply voltages ELVDD1 through ELVDD2M may be provided to the plurality of panel regions PR1 through PR2M of the display panel 110, respectively, the target voltage level of the power supply voltage ELVDD for each panel region PR may be determined by analyzing the region image data RDAT for the panel region PR, and the power supply voltage ELVDD may be changed to the target voltage level in the end portion of the emission period EMP for the panel region PR. Accordingly, the power consumption of the display device 100 may be relatively reduced while the luminance deviation or the luminance change is relatively reduced or minimized.

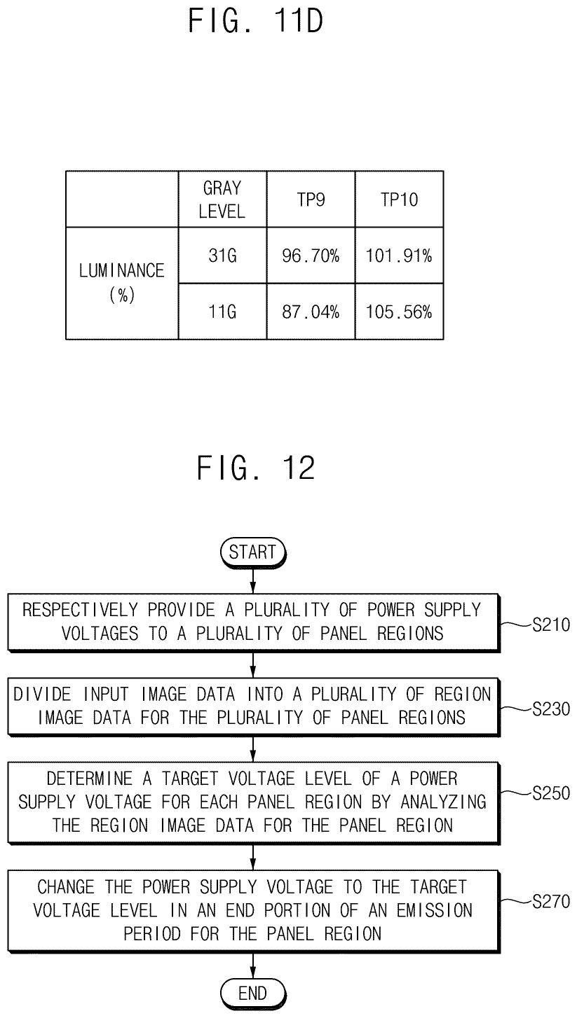

FIG. 12 is a flowchart illustrating aspects of a method of operating a display device according to some embodiments. Although FIG. 12 illustrates various operations in a method of operating a display device, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

Referring to FIGS. 1 and 12, the panel driver 120 may provide the plurality of power supply voltages ELVDD1 through ELVDD2M to the plurality of panel regions PR1 through PR2M of the display panel 110, respectively (S210).

The panel driver 120 may divide the input image data IDAT for the display panel 110 into the plurality of region image data for the plurality of panel regions PR1 through PR2M (S230), and may determine a target voltage level of a power supply voltage for each panel region among the plurality of power supply voltages ELVDD1 through ELVDD2M by analyzing the region image data for the panel region (S250). For example, the panel driver 120 may calculate an average gray level of a plurality of gray levels represented by a plurality of pixel data included in the region image data, and may determine the target voltage level of the power supply voltage based on the average gray level.

Further, the panel driver 120 may change the power supply voltage to the target voltage level in the end portion of the emission period for the panel region (S270). According to some embodiments, the panel driver 120 may change the power supply voltage to the target voltage level within a period in which the emission periods for the first through N-th pixel rows included in the panel region overlap each other. Further, according to some embodiments, the panel driver 120 may change the power supply voltage to the target voltage level one horizontal time before the end time point of the emission period for the first pixel row that is the uppermost pixel row among the first through N-th pixel rows. Accordingly, in the display device 100 according to some embodiments, the power consumption of the display device 100 may be relatively reduced while the luminance change is relatively reduced or minimized.

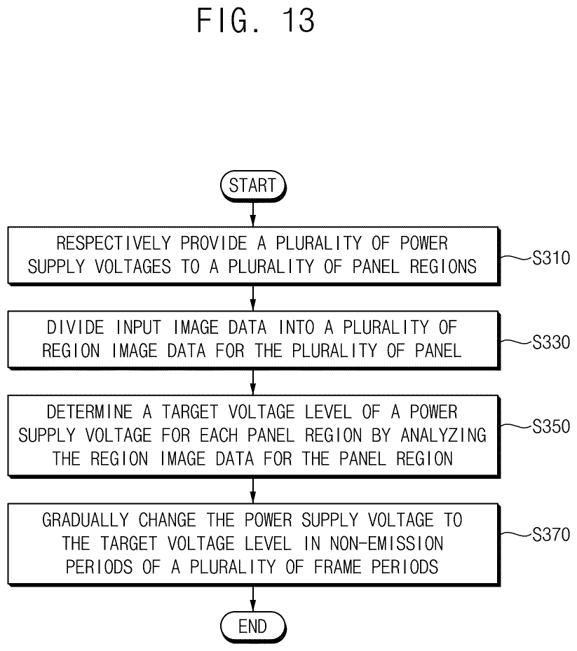

FIG. 13 is a flowchart illustrating a method of operating a display device according to some embodiments. Although FIG. 13 illustrates various operations in a method of operating a display device, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

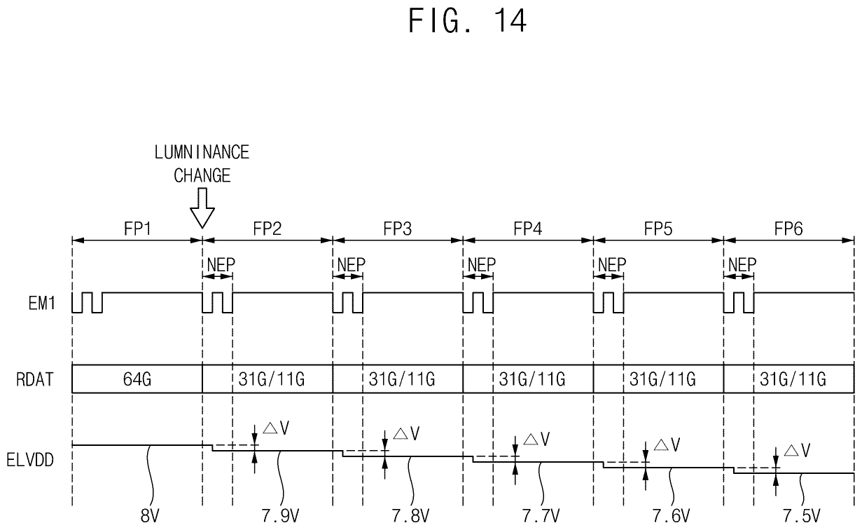

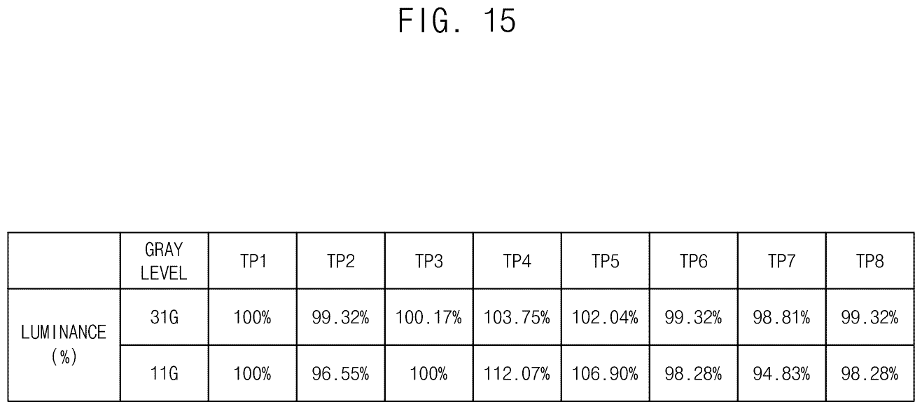

FIG. 14 is a timing diagram for describing an example in which a power supply voltage is gradually changed in non-emission periods of a plurality of frame periods according to some embodiments, and FIG. 15 is a diagram illustrating examples of luminances of a pixel row when a power supply voltage is gradually changed at first through eighth time points within non-emission periods of a plurality of frame periods.

Referring to FIGS. 1 and 13, the panel driver 120 may provide the plurality of power supply voltages ELVDD1 through ELVDD2M to the plurality of panel regions PR1 through PR2M of the display panel 110, respectively (S310).

The panel driver 120 may divide the input image data IDAT for the display panel 110 into the plurality of region image data for the plurality of panel regions PR1 through PR2M (S330), and may determine a target voltage level of a power supply voltage for each panel region among the plurality of power supply voltages ELVDD1 through ELVDD2M by analyzing the region image data for the panel region (S350).

Further, the panel driver 120 may change the power supply voltage to the target voltage level in non-emission periods of a plurality of frame periods (S370). For example, as illustrated in FIG. 14, in a case where the average gray level of the region image data RDAT for the panel region is changed from the 64-gray level 64G to the 31-gray level 31G or the 11-gray level 11G in the second frame period FP2, the panel driver 120 may gradually decrease the power supply voltage ELVDD for the panel region from about 8 V to the target voltage level of about 7.5 V in the non-emission periods NEP of second through sixth frame periods FP2, FP3, FP4, FP5 and FP6. According to some embodiments, as illustrated in FIG. 14, the panel driver 120 may change the power supply voltage ELVDD by a delta voltage (e.g., a set or predetermined delta voltage) AV in each of the non-emission periods NEP of the second through sixth frame periods FP2, FP3, FP4, FP5 and FP6 until the voltage level of the power supply voltage ELVDD becomes the target voltage level. Although FIG. 14 illustrates an example in which the delta voltage AV is about 0.1 V, the delta voltage AV in the display device 100 according to some embodiments is not limited to the example of FIG. 14. Further, according to some embodiments, the non-emission periods NEP for the first through N-th pixel rows in the panel region may be shifted by one horizontal time per each pixel row, and the panel driver 120 may change the power supply voltage ELVDD by the delta voltage AV in the period in which the non-emission periods NEP for the first through N-th pixel rows overlap each other in each of the second through sixth frame periods FP2, FP3, FP4, FP5 and FP6. As illustrated in FIG. 10C, the luminance change of up to about 85% may occur in the case where the power supply voltage ELVDD is changed to the target voltage level in the non-emission period NEP within one frame period FP2. However, in cases where the power supply voltage ELVDD is changed by the delta voltage AV at the first through eighth time points TP1 through TP8 illustrated in FIG. 10B within the non-emission period NEP of each of the second through sixth frame periods FP2, FP3, FP4, FP5 and FP6, a luminance change of up to about 12% may occur as illustrated in FIG. 15. Accordingly, in the display device 100 according to some embodiments, the power supply voltage ELVDD for each panel region may be gradually changed to the target voltage level over the plurality of frame periods FP2 through FP6, and thus the power consumption of the display device 100 may be relatively reduced while the luminance change is relatively reduced or minimized.

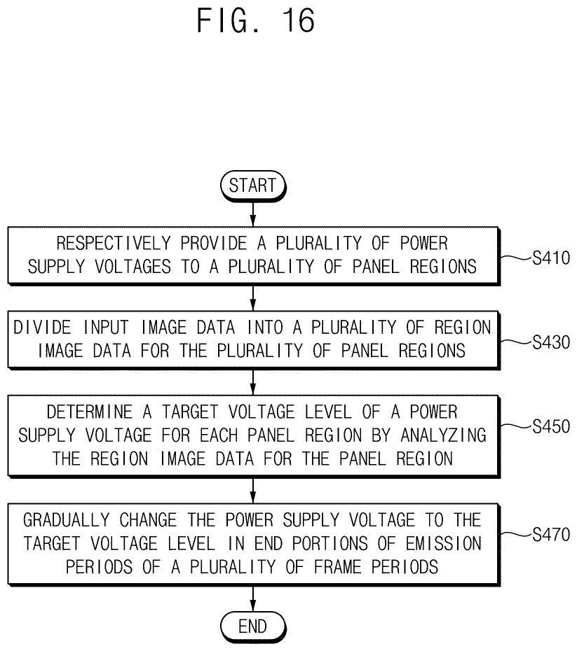

FIG. 16 is a flowchart illustrating a method of operating a display device according to some embodiments. Although FIG. 16 illustrates various operations in a method of operating a display device, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

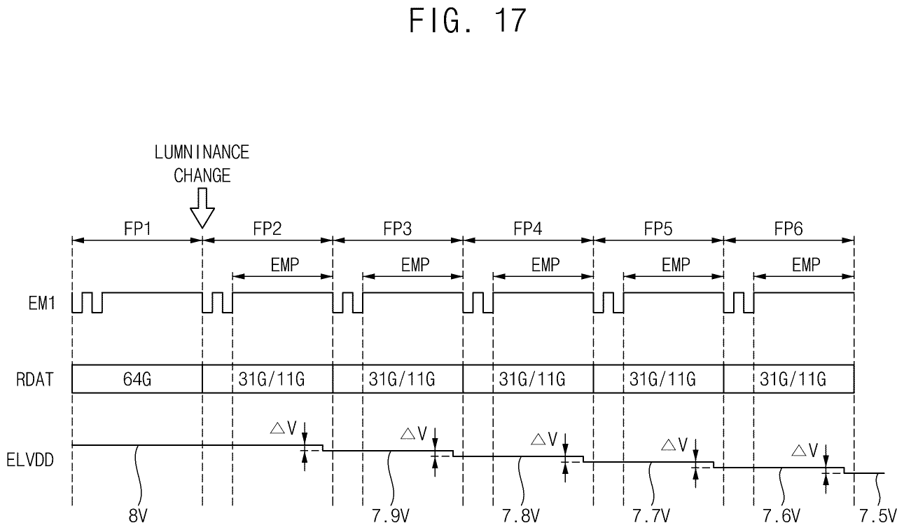

FIG. 17 is a timing diagram for describing an example in which a power supply voltage is gradually changed in end portions of emission periods of a plurality of frame periods according to some embodiments.

Referring to FIGS. 1 and 16, the panel driver 120 may provide the plurality of power supply voltages ELVDD1 through ELVDD2M to the plurality of panel regions PR1 through PR2M of the display panel 110, respectively (S410).

The panel driver 120 may divide the input image data IDAT for the display panel 110 into the plurality of region image data for the plurality of panel regions PR1 through PR2M (S430), and may determine a target voltage level of a power supply voltage for each panel region among the plurality of power supply voltages ELVDD1 through ELVDD2M by analyzing the region image data for the panel region (S450).

Further, the panel driver 120 may change the power supply voltage to the target voltage level in end portions of emission periods of a plurality of frame periods (S470). For example, as illustrated in FIG. 17, in the case where the average gray level of the region image data RDAT for the panel region is changed from the 64-gray level 64G to the 31-gray level 31G or the 11-gray level 11G in the second frame period FP2, the panel driver 120 may gradually decrease the power supply voltage ELVDD for the panel region from about 8 V to about 7.5 V that is the target voltage level in the end portions of the emission periods EMP of the second through sixth frame periods FP2, FP3, FP4, FP5 and FP6. According to some embodiments, as illustrated in FIG. 17, the panel driver 120 may change the power supply voltage ELVDD by a delta voltage (e.g., a set or predetermined delta voltage) AV at each of the end portions of the emission periods EMP of the second through sixth frame periods FP2, FP3, FP4, FP5 and FP6 until the voltage level of the power supply voltage ELVDD becomes the target voltage level. Although FIG. 17 illustrates an example in which the delta voltage AV is about 0.1 V, the delta voltage AV in the display device 100 according to some embodiments is not limited to the example of FIG. 17. Further, according to some embodiments, the emission periods EMP for the first through N-th pixel rows for the panel region may be shifted by one horizontal time per each pixel row, and the panel driver 120 may change the power supply voltage ELVDD by the delta voltage AV one horizontal time before the end time point of the emission period EMP for the first pixel row that is the uppermost pixel row among the first through N-th pixel rows in each of the second through sixth frame periods FP2, FP3, FP4, FP5 and FP6. Accordingly, in the display device 100 according to some embodiments, the power supply voltage ELVDD for each panel region may be gradually changed to the target voltage level over the plurality of frame periods FP2 through FP6, and thus the power consumption of the display device 100 may be relatively reduced while the luminance change is relatively reduced or minimized.

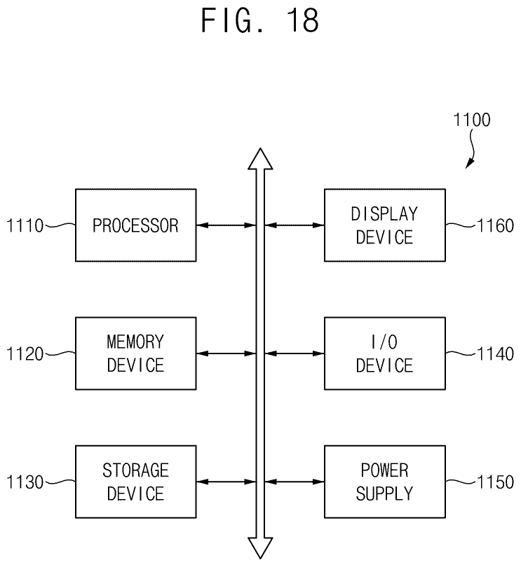

FIG. 18 is a block diagram illustrating an electronic device including a display device according to some embodiments.

Referring to FIG. 18, an electronic device 1100 may include a processor 1110, a memory device 1120, a storage device 1130, an input/output (I/O) device 1140, a power supply 1150 and a display device 1160. The electronic device 1100 may further include a plurality of ports for communicating with a video card, a sound card, a memory card, a universal serial bus (“USB”) device, other electric devices, etc.

The processor 1110 may perform various computing functions or tasks. The processor 1110 may be an application processor (“AP”), a micro-processor, a central processing unit (“CPU”), etc. The processor 1110 may be coupled to other components via an address bus, a control bus, a data bus, etc. Further, according to some embodiments, the processor 1110 may be further coupled to an extended bus such as a peripheral component interconnection (“PCI”) bus.

The memory device 1120 may store data for operations of the electronic device 1100. For example, the memory device 1120 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device such as a dynamic random access memory (“DRAM”) device, a static random access memory (“SRAM”) device, a mobile dynamic random access memory (“mobile DRAM”) device, etc.

The storage device 1130 may be a solid state drive (“SSD”) device, a hard disk drive (“HDD”) device, a compact disc-read only memory (“CD-ROM”) device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through the buses or other communication links.

In the display device 1160, a plurality of power supply voltages may be respectively provided to a plurality of panel regions of a display panel, and a target voltage level of a power supply voltage for each panel region may be determined by analyzing region image data for the panel region. Further, the power supply voltage may be changed to the target voltage level in an end portion of an emission period for the panel region, and/or may be gradually changed to the target voltage level over a plurality of frame periods. Accordingly, power consumption of the display device 1160 may be relatively reduced while a luminance change is relatively reduced or minimized.

Embodiments according to the present disclosure may be applied any electronic device 1100 including the display device 1160. For example, embodiments according to the present disclosure may be applied to a mobile phone, a smart phone, a virtual reality (“VR”) device, a television (“TV”) (e.g., a digital TV, a three-dimensional (“3D”) TV, etc.), a wearable electronic device, a personal computer (“PC”) (e.g. a laptop computer, a tablet computer, etc.), a home appliance, a personal digital assistant (“PDA”), a portable multimedia player (“PMP”), a digital camera, a music player, a portable game console, a navigation device, etc.

The foregoing is illustrative of embodiments and is not to be construed as limiting thereof. Although a few embodiments have been described, those skilled in the art will readily appreciate that many modifications are possible in the embodiments without materially departing from the novel teachings and characteristics of embodiments according to the present disclosure. Accordingly, all such modifications are intended to be included within the scope of embodiments according to the present disclosure as defined in the appended claims, and their equivalents. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims, and their equivalents.

What is claimed is:

1. A display device comprising:
a display panel including a plurality of pixels, the display panel being divided into a plurality of panel regions; and
a panel driver configured to drive the display panel based on input image data, and to provide a plurality of power supply voltages to the plurality of panel regions, respectively,
wherein the panel driver is further configured to:
divide the input image data for the display panel into a plurality of region image data for the plurality of panel regions;
determine a target voltage level of each of the plurality of power supply voltages by analyzing a corresponding one of plurality of region image data; and
change each of the plurality of power supply voltages to the target voltage level in an end portion of an emission period for a corresponding one of the plurality of panel regions.

2. The display device of claim 1, wherein the plurality of panel regions respectively includes a plurality of mesh lines that are electrically disconnected from each other, and
wherein the panel driver is configured to provide the plurality of power supply voltages to the plurality of mesh lines of the plurality of panel regions, respectively.

3. The display device of claim 1, wherein the panel driver is configured to calculate an average gray level of a plurality of gray levels represented by a plurality of pixel data included in the corresponding one of plurality of region image data, and to determine the target voltage level of a corresponding one of the plurality of power supply voltages based on the average gray level.

4. The display device of claim 3, wherein the panel driver includes:
a gray-voltage lookup table configured to store a plurality of voltage levels corresponding to a plurality of gray ranges,
wherein the panel driver is configured to receive a voltage level corresponding to a gray range to which the average gray level belongs among the plurality of gray ranges from the gray-voltage lookup table, and to determine the target voltage level of the corresponding one of the plurality of power supply voltages as the voltage level received from the gray-voltage lookup table.

5. The display device of claim 1, wherein each of the plurality of panel regions includes the plurality of pixels arranged in first through N-th pixel rows, where N is an integer greater than 1,
wherein emission periods for the first through N-th pixel rows are shifted by one horizontal time per each pixel row, and
wherein the panel driver is configured to change a corresponding one of the plurality of power supply voltages to the target voltage level within a period in which the emission periods overlap each other.

6. The display device of claim 1, wherein each of the plurality of panel regions includes the plurality of pixels arranged in first through N-th pixel rows, where N is an integer greater than 1, and
wherein the panel driver is configured to change a corresponding one of the plurality of power supply voltages to the target voltage level one horizontal time before an end time point of an emission period for a first pixel row that is an uppermost pixel row among the first through N-th pixel rows.

7. The display device of claim 1, wherein each of the plurality of pixels includes:
a first transistor including a gate connected to a gate node, a drain, and a source connected to a source node;
a second transistor configured to transfer a data voltage to the gate node in response to a write signal;
a third transistor configured to transfer a reference voltage to the gate node in response to a reference signal;
a fourth transistor configured to transfer an initialization voltage to an anode of a light emitting element in response to an initialization signal;
a fifth transistor configured to transfer a corresponding one of the plurality of power supply voltages to the drain of the first transistor in response to a first emission signal;
a sixth transistor configured to connect the source node to the anode of the light emitting element in response to a second emission signal;
a storage capacitor including a first electrode connected to the gate node, and a second electrode connected to the source node;
a hold capacitor including a first electrode configured to receive the reference voltage, and a second electrode connected to the source node; and
the light emitting element including the anode connected to the fourth and sixth transistors, and a cathode configured to receive a low power supply voltage.

8. The display device of claim 7, wherein the first transistor further includes a bottom gate connected to the source node.

9. The display device of claim 7, wherein the second transistor includes a gate configured to receive the write signal, a first terminal connected to a data line, and a second terminal connected to the gate node,
wherein the third transistor includes a gate configured to receive the reference signal, a first terminal configured to receive the reference voltage, and a second terminal connected to the gate node,
wherein the fourth transistor includes a gate configured to receive the initialization signal, a first terminal connected to the anode of the light emitting element, and a second terminal configured to receive the initialization voltage,
wherein the fifth transistor includes a gate configured to receive the first emission signal, a first terminal configured to receive the corresponding one of the plurality of power supply voltages, and a second terminal connected to the drain of the first transistor, and
wherein the sixth transistor includes a gate configured to receive the second emission signal, a first terminal connected to the source node, and a second terminal connected to the anode of the light emitting element.

10. The display device of claim 1, wherein the panel driver includes:
a data driver configured to provide data voltages to the plurality of pixels;
a scan driver configured to provide scan signals to the plurality of pixels;
an emission driver configured to provide emission signals to the plurality of pixels;
a power management circuit configured to provide the plurality of power supply voltages to the plurality of panel regions, respectively; and
a controller configured to control the data driver, the scan driver, the emission driver and the power management circuit.

11. A display device comprising:
a display panel including a plurality of pixels, the display panel being divided into a plurality of panel regions; and
a panel driver configured to drive the display panel based on input image data, and to provide a plurality of power supply voltages to the plurality of panel regions, respectively,
wherein the panel driver is further configured to:
divide the input image data for the display panel into a plurality of region image data for the plurality of panel regions;
determine a target voltage level of each of the plurality of power supply voltages by analyzing a corresponding one of plurality of region image data; and
gradually change each of the plurality of power supply voltages to the target voltage level over a plurality of frame periods.

12. The display device of claim 11, wherein the plurality of panel regions respectively includes a plurality of mesh lines that are electrically disconnected from each other, and
wherein the panel driver is configured to provide the plurality of power supply voltages to the plurality of mesh lines of the plurality of panel regions, respectively.

13. The display device of claim 11, wherein the panel driver is configured to calculate an average gray level of a plurality of gray levels represented by a plurality of pixel data included in the corresponding one of plurality of region image data, and to determine the target voltage level of a corresponding one of the plurality of power supply voltages based on the average gray level.

14. The display device of claim 13, wherein the panel driver includes:
a gray-voltage lookup table configured to store a plurality of voltage levels corresponding to a plurality of gray ranges,
wherein the panel driver is configured to receive a voltage level corresponding to a gray range to which the average gray level belongs among the plurality of gray ranges from the gray-voltage lookup table, and to determine the target voltage level of the corresponding one of the plurality of power supply voltages as the voltage level received from the gray-voltage lookup table.

15. The display device of claim 11, wherein the panel driver is configured to change a corresponding one of the plurality of power supply voltages by a predetermined delta voltage in each of the plurality of frame periods until a voltage level of the corresponding one of the plurality of power supply voltages becomes the target voltage level.

16. The display device of claim 11, wherein each of the plurality of panel regions includes the plurality of pixels arranged in first through N-th pixel rows, where N is an integer greater than 1,
wherein non-emission periods for the first through N-th pixel rows are shifted by one horizontal time per each pixel row, and
wherein the panel driver is configured to change a corresponding one of the plurality of power supply voltages by a predetermined delta voltage in a period in which the non-emission periods overlap within each of the plurality of frame periods.

17. The display device of claim 11, wherein each of the plurality of panel regions includes the plurality of pixels arranged in first through N-th pixel rows, where N is an integer greater than 1,
wherein the panel driver is configured to change a corresponding one of the plurality of power supply voltages by a predetermined delta voltage one horizontal time before an end time point of an emission period for a first pixel row that is an uppermost pixel row among the first through N-th pixel rows in each of the plurality of frame periods.

18. The display device of claim 11, wherein each of the plurality of pixels includes:
a first transistor including a gate connected to a gate node, a drain, and a source connected to a source node;
a second transistor configured to transfer a data voltage to the gate node in response to a write signal;
a third transistor configured to transfer a reference voltage to the gate node in response to a reference signal;
a fourth transistor configured to transfer an initialization voltage to an anode of a light emitting element in response to an initialization signal;
a fifth transistor configured to transfer a corresponding one of the plurality of power supply voltages to the drain of the first transistor in response to a first emission signal;
a sixth transistor configured to connect the source node to the anode of the light emitting element in response to a second emission signal;
a storage capacitor including a first electrode connected to the gate node, and a second electrode connected to the source node;
a hold capacitor including a first electrode configured to receive the reference voltage, and a second electrode connected to the source node; and
the light emitting element including the anode connected to the fourth and sixth transistors, and a cathode configured to receive a low power supply voltage.

19. The display device of claim 18, wherein the first transistor further includes a bottom gate connected to the source node,
wherein the second transistor includes a gate configured to receive the write signal, a first terminal connected to a data line, and a second terminal connected to the gate node,
wherein the third transistor includes a gate configured to receive the reference signal, a first terminal configured to receive the reference voltage, and a second terminal connected to the gate node,
wherein the fourth transistor includes a gate configured to receive the initialization signal, a first terminal connected to the anode of the light emitting element, and a second terminal configured to receive the initialization voltage,
wherein the fifth transistor includes a gate configured to receive the first emission signal, a first terminal configured to receive the corresponding one of the plurality of power supply voltages, and a second terminal connected to the drain of the first transistor, and
wherein the sixth transistor includes a gate configured to receive the second emission signal, a first terminal connected to the source node, and a second terminal connected to the anode of the light emitting element.

20. An electronic device comprising:
a processor configured to provide input image data; and
a display device configured to display an image based on the input image data, the display device including:
a display panel including a plurality of pixels, the display panel being divided into a plurality of panel regions; and
a panel driver configured to drive the display panel based on input image data, and to provide a plurality of power supply voltages to the plurality of panel regions, respectively,
wherein the panel driver is further configured to:
divide the input image data for the display panel into a plurality of region image data for the plurality of panel regions;
determine a target voltage level of each of the plurality of power supply voltages by analyzing a corresponding one of plurality of region image data; and
change each of the plurality of power supply voltages to the target voltage level in an end portion of an emission period for a corresponding one of the plurality of panel regions.
